(19) United States
(12) Patent Application Publication
(10) Pub. No.: US 2026/0357943 A1
(43) Pub. Date: Nov. 12, 2026

(54) INSULATION PIPE SUPPORT RING

(71) Applicant: DIRECTLY TECHNOLOGY CO., LTD., Hsinchu City (TW)

(72) Inventor: SHIH-HAO TANG, Hsinchu City (TW)

(21) Appl. No.: 19/204,353

(22) Filed: May 9, 2025

(51) Int. Cl. F16L 59/135; F16L 59/02

(52) U.S. Cl. CPC F16L 59/135; F16L 59/022; F16L 59/024

(57) ABSTRACT

An insulation pipe support ring is provided. The insulation pipe support ring comprises an annular collar and a central bore formed centrally with respect to the annular collar. The central bore is configured to be sleeved around an outer surface of an insulated transport pipe. The annular collar is composed of a polymer material having thermal insulation and high compressive strength properties, the polymer material having a thermal conductivity coefficient in a range from 0.2 to 0.4 W/MK, a compressive strength in a range from 100 to 2000 kgf/cm², a high-temperature resistance in a range from 170° C to 240° C, and a thickness in a range from 5 mm to 25 mm. The annular collar is further provided with an anti-rotation mechanism including a radial protrusion configured to press against the insulated transport pipe, thereby maintaining a relative position of the annular collar.

### FIELD OF INVENTION

The present invention relates to pipe support devices, and more particularly to an insulation pipe support ring having an innovative structural configuration designed for use with insulated fluid transport piping.

### BACKGROUND OF THE INVENTION

In practical manufacturing and processing environments, certain operations require the transport of high-temperature fluids via extended piping systems, wherein it is critical to maintain the fluid at a stable and controlled temperature throughout the transport.

To this end, it is common industry practice to wrap the outer surfaces of piping with thermal insulation materials to reduce heat loss. However, as such piping systems often extend over considerable distances, pipe support structures must be installed at regular intervals along the pipeline to provide mechanical stability and positional retention. A persistent drawback recognized in existing solutions is that conventional pipe support structures are typically fabricated from highly rigid metallic materials possessing excellent thermal conductivity. As these structures are designed to clamp directly onto the pipe surface, thermal energy from the pipe is then readily transferred outward through the support structures, creating a significant thermal bridge that compromises the overall effectiveness of the insulation system.

While it is theoretically possible to apply conventional foam-based insulation materials around the support structures themselves, such materials generally lack the requisite compressive strength and mechanical integrity required to bear the load of the piping system and to maintain long-term stability. As a result, there is a critical need for a structurally and thermally optimized support device that can overcome the limitations of existing insulation and support mechanisms.

### SUMMARY OF THE INVENTION

The primary objective of the present invention is to provide an insulation pipe support ring that overcomes the aforementioned limitations by offering a more practical and structurally innovative solution. Specifically, the insulation pipe support ring is configured for installation at pipe support interfaces where pipe clamp assemblies engage an insulated transport pipe.

To achieve the stated objective, the technical features of the present invention lie in An insulation pipe support ring configured for installation at a support interface of a pipe clamp assembly on an insulated transport pipe, the insulation pipe support ring comprising:an annular collar; and a central bore formed centrally with respect to the annular collar and configured to be sleeved around an outer surface of the insulated transport pipe;wherein the annular collar is composed of a polymer material having thermal insulation and high compressive strength properties, the polymer material having a thermal conductivity coefficient in a range from 0.2 to 0.4 W/MK, a compressive strength in a range from 100 to 2000 kgf/cm², a high-temperature resistance in a range from 170° C to 240° C, and a thickness in a range from 5 mm to 25 mm.

wherein the annular collar is further provided with an anti-rotation mechanism comprising a radial protrusion configured to press against the insulated transport pipe so as to maintain a relative position of the annular collar.

The present invention offers several notable advantages. Chief among these is the ability to significantly reduce thermal conduction between the insulated transport pipe and the pipe clamp assemblies, thereby enhancing thermal efficiency and contributing to energy conservation. In addition, the inclusion of an anti-rotation mechanism can compensate for the inherent tendency of the annular collar composed of polymeric material to slip, thus ensuring secure and stable positioning of the insulation pipe support ring during use.

Another objective of the present invention is achieved by providing the annular collar with a plurality of longitudinal channels. Each longitudinal channel is formed in alignment with the central bore and includes an opening that is sealed by a sealing cover, thereby forming a plurality of enclosed air chambers. The presence of these sealed air chambers further enhances the thermal insulation performance of the insulation pipe support ring.

A further objective is realized by filling each of the longitudinal channels with a thermal insulation material. The inclusion of these materials within the longitudinal channels improves the overall thermal insulation effect.

Yet another objective is accomplished by employing a specific configuration of the thermal insulation material, wherein the insulation material comprises a flexible pouch that encloses an aerogel. Aerogel is recognized as one of the lightest known solid materials, with exceptionally low thermal conductivity. The use of such a configuration significantly enhances the thermal insulation efficiency of the insulation pipe support ring.

### BRIEF DESCRIPTION OF THE DRAWINGS

FIG. 1 is a perspective assembly view of a preferred embodiment of the insulation pipe support ring;

FIG. 2 is an exploded perspective view of the preferred embodiment;

FIG. 3 is a cross-sectional view of the preferred embodiment;

FIG. 4 is a perspective view of another preferred embodiment;

FIG. 5 is a cross-sectional view of another preferred embodiment;

FIG. 6 is a perspective view of yet another preferred embodiment;

FIG. 7 is a cross-sectional view of yet another preferred embodiment;

FIG. 8 illustrates a variant where the longitudinal channels are filled with thermal insulation material;

FIG. 9 is a perspective view of a variant where the thermal insulation material includes a flexible pouch enclosing aerogel;

FIG. 10 is a cross-sectional view corresponding to FIG. 9; and

FIG. 11 is an enlarged view of the area marked "11" in FIG. 10.

### DETAILED DESCRIPTION OF THE PREFERRED EMBODIMENTS

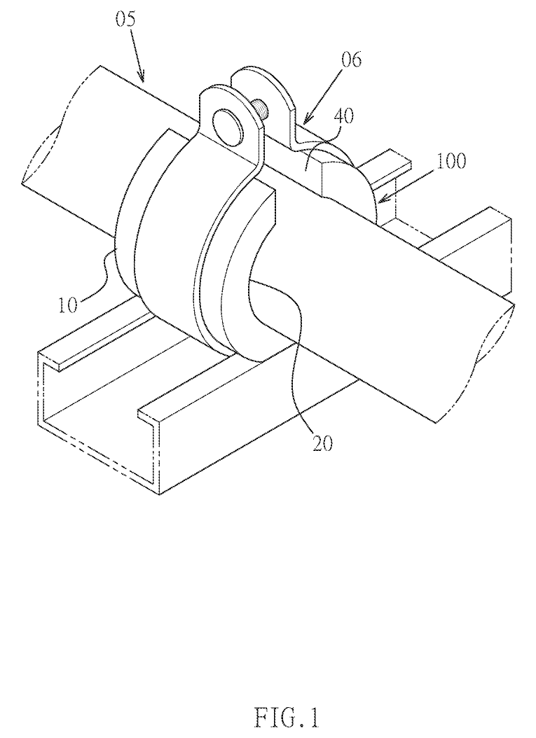

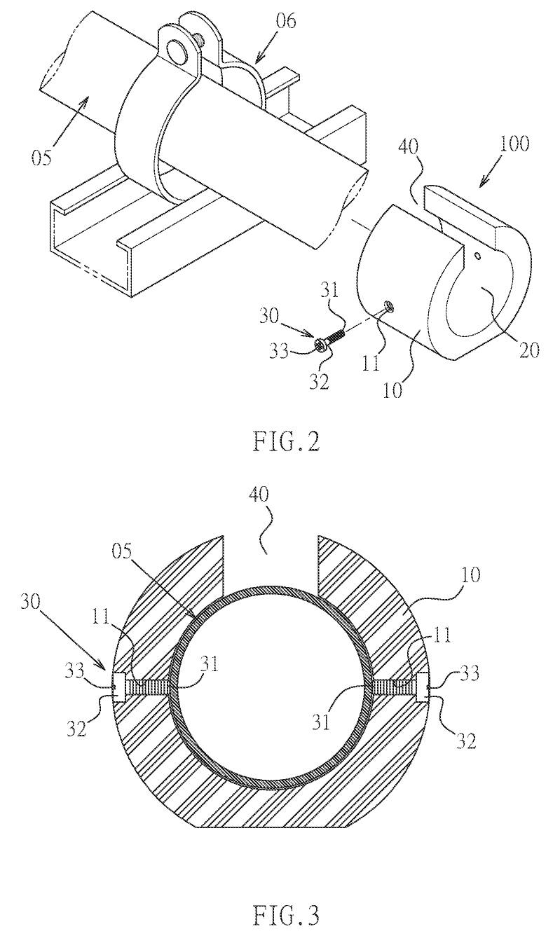

Referring to FIGS. 1-4, a preferred embodiment of an insulation pipe support ring 100 according to the present invention is illustrated. It is to be understood that these embodiments are provided solely for purposes of illustration and description, and are not intended to limit the scope of the claimed invention.

The insulation pipe support ring 100 is specifically configured for installation at support interfaces 06 of pipe clamp assemblies that are positioned along an insulated transport pipe 05. The insulation pipe support ring 100 comprises an annular collar 10 and a central bore 20 that is centrally formed with respect to the annular collar 10. The central bore 20 is configured to be sleeved around an outer surface of the insulated transport pipe 05. The annular collar 10 is composed of a polymer material that has both thermal insulating properties and high compressive strength. The polymer material features a thermal conductivity coefficient in the range of 0.2 to 0.4 W/MK, a compressive strength ranging from 100 to 2000 kgf/cm², a high-temperature resistance in the range of 170° C to 240° C, and a thickness ranging from 5 mm to 25 mm. Furthermore, the annular collar 10 is provided with an anti-rotation mechanism 30. The anti-rotation mechanism 30 includes a radial protrusion 31 that is configured to press against the insulated transport pipe 05, thereby maintaining the relative position of the annular collar 10 and preventing slippage during use.

The polymer material forming the annular collar 10 includes at least one selected from the group consisting of polytetrafluoroethylene (PTFE), polyetheretherketone (PEEK), and polyphenylene sulfide (PPS). These materials are high-performance polymers that exhibit excellent electrical and electronic properties, arc resistance, and the ability to maintain ideal mechanical strength and chemical corrosion resistance even in environments exceeding 200° C.

As shown in FIG. 2, in the illustrated embodiment, the annular collar 10 of the insulation pipe support ring 100 is further formed with a relief opening 40 on an upper side thereof, such that the annular collar 10 assumes a non-enclosed C-shaped profile.

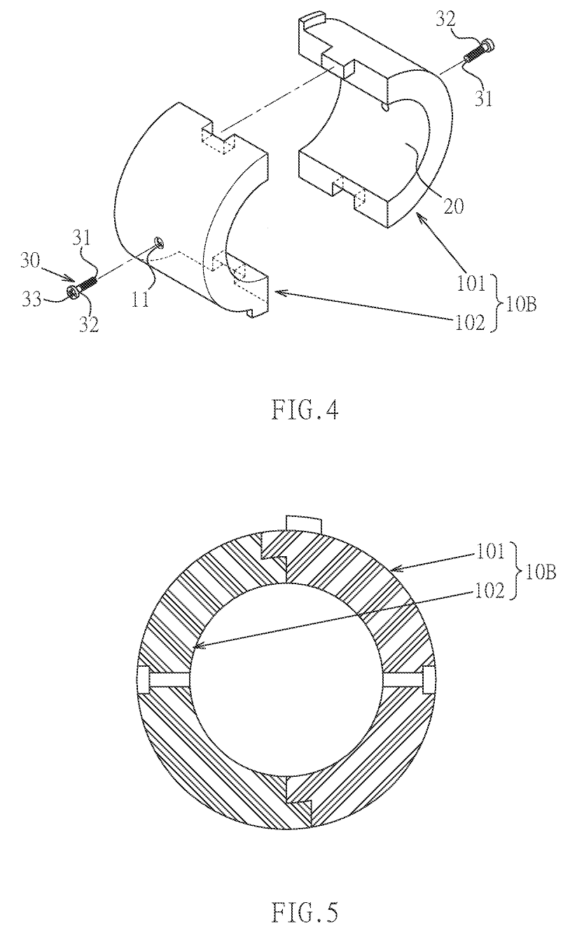

As shown in FIGS. 4 and 5, in another embodiment, an annular collar 10B of the insulation pipe support ring 100 comprises two hemispherical segments 101 and 102 that are joined together to form an annular structure.

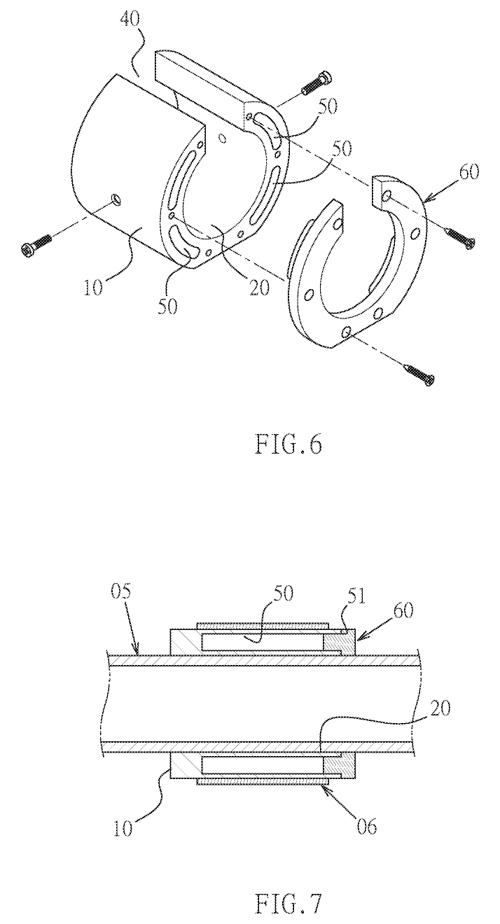

As shown in FIGS. 6 and 7, in a further embodiment, the annular collar 10 of the insulation pipe support ring 100 is formed with a plurality of longitudinal channels 50. Each longitudinal channel 50 is formed in alignment with the central bore 20 and includes an opening 51. Each opening 51 is sealed by a corresponding sealing cover 60, such that a plurality of enclosed air chambers is defined within the annular collar 10. The formation of these enclosed air chambers contributes to enhanced thermal insulation performance of the insulation pipe support ring 100.

As shown in FIG. 6, each longitudinal channel 50 is filled with a thermal insulation material 70. The thermal insulation material 70 comprises at least one material selected from the group consisting of cellulose, glass wool, rock wool, polystyrene, polyurethane, vermiculite, perlite, plant or animal fibers (e.g., hemp, flax, cotton, cork, sheep wool), fabric, plant straw, clay, and aerogel. By filling the longitudinal channels 50 with the thermal insulation material 70, the insulation performance of the insulation pipe support ring 100 is further improved.

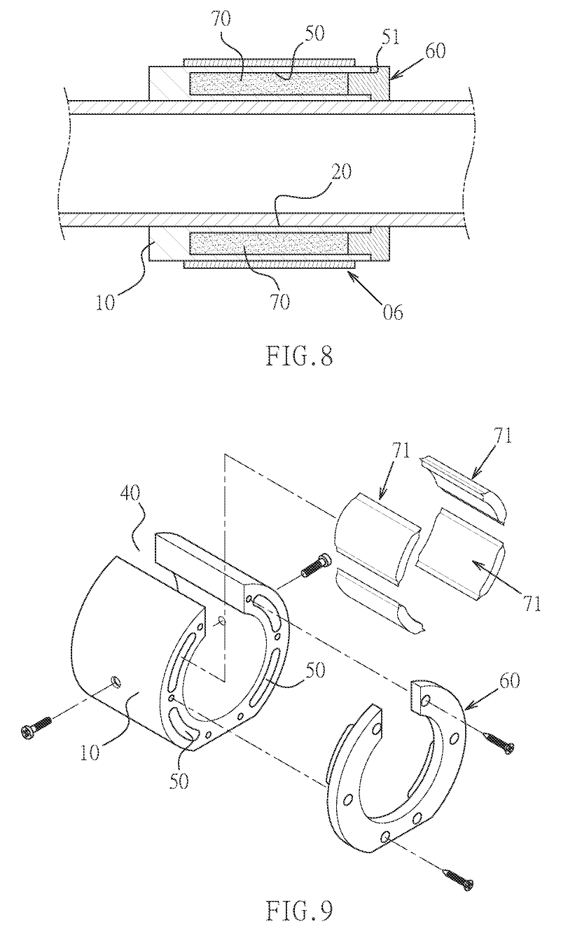

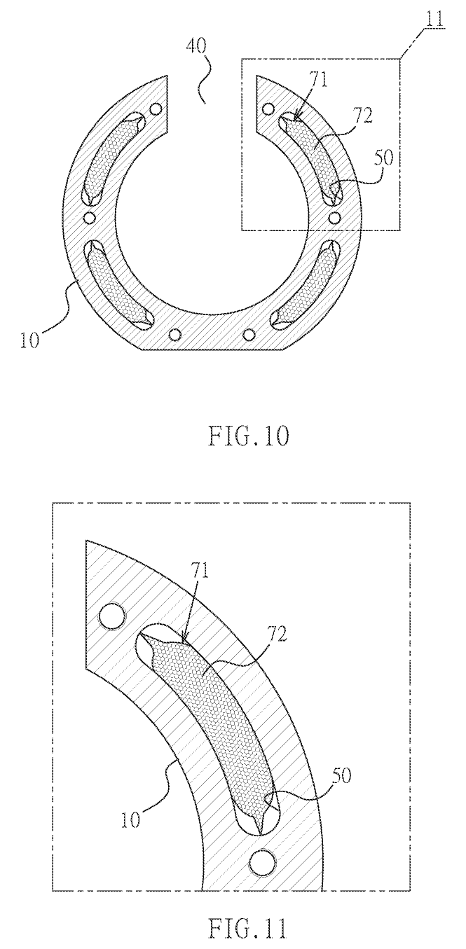

As shown in FIGS. 7-9, in a still further embodiment, the thermal insulation material 70 comprises a flexible pouch 71 that encloses an aerogel 72. The aerogel 72 is recognized as one of the lightest solid materials currently available and exhibits an exceptionally low thermal conductivity. Incorporation of the aerogel 72 into the structure of the insulation pipe support ring 100 significantly enhances its thermal insulation efficiency.

As shown in FIGS. 1-3, in the illustrated embodiment, the anti-rotation mechanism 30 comprises a plurality of fasteners 32. The annular collar 10 is provided with threaded holes 11 formed on opposite sides thereof for threaded engagement with the fasteners 32. One end of each fastener 32 forms the radial protrusion 31, while an opposite end forms a tool engagement end 33, which may be configured as a flathead, Phillips, or hexagonal socket, for engagement with conventional tools such as screwdrivers or wrenches to facilitate fastening.

With the foregoing structural configuration and technical features, the insulation pipe support ring 100 of the present invention is applied, as illustrated in FIGS. 1-3, at the support interfaces 06 of pipe clamp assemblies along the insulated transport pipe 05. As shown in FIG. 1, the support interfaces 06 commonly include combinations of C-shaped steel and P-type pipe clamps as used in the industry. The insulation pipe support ring 100 is positioned within the P-type pipe clamp and wraps around the outer surface of the insulated transport pipe 05. Owing to the fact that the annular collar 10 is fabricated from a polymer material exhibiting both thermal insulation and high compressive strength, it effectively and significantly reduces thermal conduction between the insulated transport pipe 05 and the support interfaces 06 of the pipe clamp assemblies, thereby achieving energy-saving benefits. Moreover, the anti-rotation mechanism 30 mitigates the tendency of the annular collar 10 to slip as a result of its polymer composition, thereby ensuring stable positioning of the insulation pipe support ring 100 during use.

What is claimed is:

1. An insulation pipe support ring configured for installation at a support interface of a pipe clamp assembly on an insulated transport pipe, the insulation pipe support ring comprising:
an annular collar; and
a central bore formed centrally with respect to the annular collar and configured to be sleeved around an outer surface of the insulated transport pipe;
wherein the annular collar is composed of a polymer material having thermal insulation and high compressive strength properties, the polymer material having a thermal conductivity coefficient in a range from 0.2 to 0.4 W/MK, a compressive strength in a range from 100 to 2000 kgf/cm², a high-temperature resistance in a range from 170° C to 240° C, and a thickness in a range from 5 mm to 25 mm;
wherein the annular collar is further provided with an anti-rotation mechanism comprising a radial protrusion configured to press against the insulated transport pipe so as to maintain a relative position of the annular collar.

2. The insulation pipe support ring according to claim 1, wherein the polymer material comprises at least one selected from the group consisting of polytetrafluoroethylene, polyetheretherketone, and polyphenylene sulfide.

3. The insulation pipe support ring according to claim 1, wherein the annular collar includes a relief opening formed on a top side thereof, such that the annular collar defines a non-enclosed C-shaped profile.

4. The insulation pipe support ring according to claim 1, wherein the annular collar comprises two hemispherical segments joined together to form an annular structure.

5. The insulation pipe support ring according to claim 1, wherein the annular collar further comprises a plurality of longitudinal channels, each longitudinal channel being aligned with the central bore and having an opening sealed by a sealing cover.

6. The insulation pipe support ring according to claim 5, wherein each of the longitudinal channels is filled with a thermal insulation material.

7. The insulation pipe support ring according to claim 6, wherein the thermal insulation material comprises at least one selected from the group consisting of cellulose, glass wool, rock wool, polystyrene, polyurethane, vermiculite, perlite, plant or animal fibers, fabric, plant straw, clay, and aerogel.

8. The insulation pipe support ring according to claim 6, wherein the thermal insulation material comprises a flexible pouch enclosing an aerogel.

9. The insulation pipe support ring according to claim 1, wherein the anti-rotation mechanism comprises a plurality of fasteners, each fastener extending through a threaded hole formed on opposite sides of the annular collar, each fastener having one end forming the radial protrusion and the other end forming a tool engagement end configured for engagement with a tool.
